(19) United States
(12) Patent Application Publication
(10) Pub. No.: US 2020/0254952 A1
(43) Pub. Date: Aug. 13, 2020

(54) Collision safer vehicles having a steering wheel with dual positions and collision-retreat seats

(71) Applicant: Hongjun Pan, Lewisville, TX (US)

(72) Inventor: Hongjun Pan, Lewisville, TX (US)

(21) Appl. No.: 16/269,805

(22) Filed: Feb. 7, 2019

(51) Int. Cl. B60R 21/09; B62D 3/12; B62D 1/18; B60R 21/05; B60N 2/02

(52) U.S. Cl. CPC B60R 21/09; B62D 3/12; B62D 7/16; B60R 21/05; B60N 2/0276; B62D 1/18

(57) ABSTRACT

A new type of vehicles is disclosed that equipped with a steering wheel which can be located and operated either in side location or in central location. The information display panel, the brake pedal, and the acceleration pedal can be moved along with the steering wheel, the central convenient cabin can be moved to side also. When the steering wheel is located at the central position, additional about 1 foot or more collision cushion space is created which will substantially reduce the injuries and fatal casualties caused by side collisions. The new type of the vehicles disclosed here can also be equipped with collision-retreat vehicle seats, such collision-retreat seats can be pushed backward through proper mechanism when the front-end collisions happen; such seat backward retreat will create additional collision cushion space between the front occupants and the frontal elements such as steering wheel, dashboard and windshield glass, the severity of the injuries and fatal casualties will be substantially reduced, lives will be saved.

### THE BACKGROUND OF INVENTION

### Field of the Invention

The present invention relates generally to automobile vehicles, and, more particularly, to the automobile vehicles having a steering wheel with dual operation positions and collision-retreat vehicle seats, so the severity of collision on the occupants will be substantially reduced, and lives will be saved.

### DESCRIPTION OF THE PRIOR ART

In modern society, the automobiles are the most commonly used for transportation in our daily life, collision accidents can happen at anywhere and anytime. Nearly 1.3 million people die in road crashes each year, on average 3,287 deaths a day. An additional 20-50 million are injured or disabled. Safety is the most important concern. There are huge number of prior arts in this aspect. Safety belts and air bags are well known in the art now and become essential items in automobile vehicles. Some other patents are listed here as examples: the U.S. Pat. No. 3,794,136(A) and KR201000073922 (A) disclosed early alerting/detection systems for collision; the patent KR20120005214(A) disclosed an impact absorbing system installed along the road; the U.S. Pat. No. 9,067,617 B2 disclosed a safety device for orienting a vehicle front wheel transversally to the longitudinal direction following a collision. I invented a collision safer device with U.S. patent application Ser. No. 15/890,525 in 2018. In this invention, a free rotation wheel is installed at the front left and right corners to divert the harmful collision force and substantially reduce the harmful impact force on the occupants and the vehicles, save lives and reduce property damages; the collision safer devices can also substantially reduce the severity of the rear-end collisions, save lives. This invention was presented at international automobile conference and the research paper was published in a reputable automobile research journal [1]. However, the collision safer device only reduce the harmful collision force for those collisions with relatively small collision angles (less than 45 degree), the direct head-on collision are most deadly collisions due to relative large collision energy, in nowadays, the crumple zone structure in frontal part of vehicle will reduce the impact energy on the occupants and the safety belts and airbags will reduce the severity of the collision also, but it is not enough, head-on collision is still the most deadly collisions. Side impact crashes accounted for 27% of vehicle occupant deaths in US in 2009 [2], such crashes can be particularly deadly because the sides of vehicle have relatively little space to absorb energy and shield occupants. The effort to reduce the collision severity and save lives continues. In the present invention, a new type of automobile vehicle is disclosed, this new type of the vehicle has a steering wheel with dual operation positions and collision-retreat seats, additional open cushion space is created, the severity of the collision on the occupants will be substantially reduced, save lives for side impact collisions and the head-on collisions.

### SUMMARY OF THE INVENTION

In present invention, the new type of vehicle has a steering wheel which has two locations, the said steering wheel can be either at side (left side such as in US, right side in England) or at the middle of vehicle, the said steering wheel can be easily moved by the driver between the two locations depending on the his/her preference and actual situation. If the said steering wheel is settled at the middle of the vehicle, it will create about additional 1 foot (30 cm) open cushion space between the side door and the body of the driver to absorb the side impact energy, the severity of the side impact collision will be substantially reduced, lives will be saved.

In this invention, the said new type of the vehicle has the collision-retreat seats, the said collision-retreat seats will be pushed back by the seat-retreat activation unit, such retreat movement will create additional open cushion space between the frontal occupants and the said steering wheel/dashboard area, so the collision impact on the frontal occupants will be substantially reduced, the severity of injuries will be substantially reduced, lives will be saved. The present invention can be better illustrated by the following drawings and detailed description.

### BRIEF DESCRIPTION OF DRAWINGS

FIG. 1 shows the steering wheel at the left side (US style).

FIG. 2 shows the steering wheel at the middle.

FIG. 3 shows that the steering wheel is moved from side position to central position in Pinion-rack structure.

FIG. 4 shows the structure of the vehicle seat rack with a T slot in each side.

FIG. 5 shows the structure of chassis frame with T bar and the seat-retreat activation unit on the top of the chassis frame.

FIG. 6 shows the assembly of the seat rack on the chassis frame.

FIG. 7 shows the seats installed on the seat rack.

FIG. 8 shows that the seats are pushed back during the head-on collision.

FIG. 9 shows the two frontal seats on the seat-retreat rack when the steering wheel with dua position is not applied.

### DESCRIPTION OF THE PREFERRED EMBODIMENT

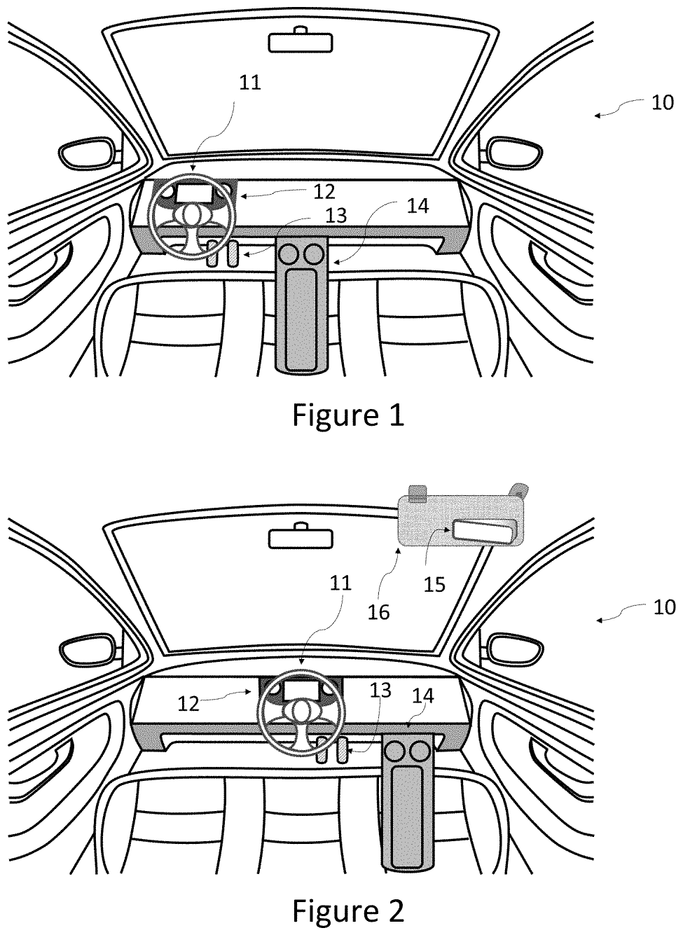

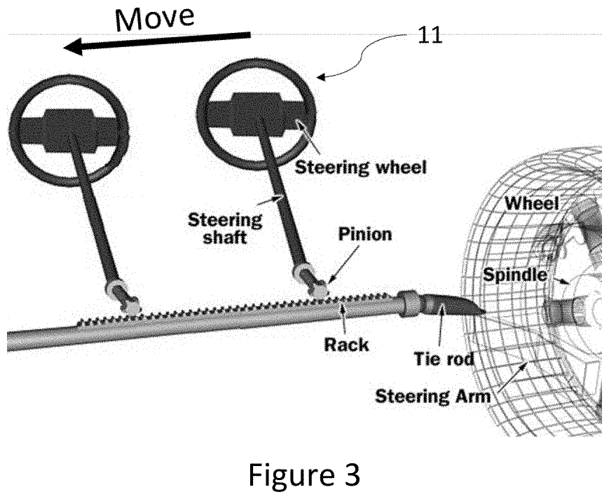

FIG. 1 shows that in normal situation, the steering wheel 11 is located at left side of vehicle 10 (US style). When the side impact collision happens at the left side, most likely, the driver will be injured or killed if the impact is hard enough because there is very little space between the body of the driver and the left door. However, it is notable that the most of the vehicles on the roads are used by working people for daily commute and for business, only one occupant is in those vehicles, most of collision casualties happen to those single occupants. If the said steering wheel 11 is designed in such way that it can be moved easily by common people to the central position of the said vehicle 10 and firmly locked in such position shown in FIG. 2, the driver will have the options to operate the said vehicle 10 either in side position or in the central position. If in the central position, it will create about additional 1-foot (30 cm) open cushion space between the body of the driver and the left door, when the side impact collision happens at the left side, such 1-foot additional open space will substantially reduce the side impact injury, save lives. FIG. 3 shows that the said steering wheel 11 is moved from side to central position for the pinion-rack structure with longer rack. For common passenger vehicles or family vehicles, only the driver can sit in the front seat when the said vehicle 10 is operated with the said central steering wheel 11, other people have to sit in the back seats for safety reason. A second rear-view mirror 15 can be installed on the right side visor 16 for use when the driver sits in the central position shown in FIG. 2. The information display panel 12 (includes the speed meter, engine-running meter and other information indicators), the brake pedal and the acceleration pedal 13 can be made in one module so the its moving is made easy, the central convenient cabin 14 (orange color) can be moved to the right side before moving the said steering wheel 11. The new technology of “Drive-by-wire” or “Steer-by-wire” are well fit into the application of the steering wheel with dual positions, because it requires much less part movements

FIG. 3 shows that the said steering wheel 11 is relatively easy to be moved from side position to the central position with pinion-rack structure. The rack is made much longer than normal rack, so the modification to the pinion-rack structure is minimized.

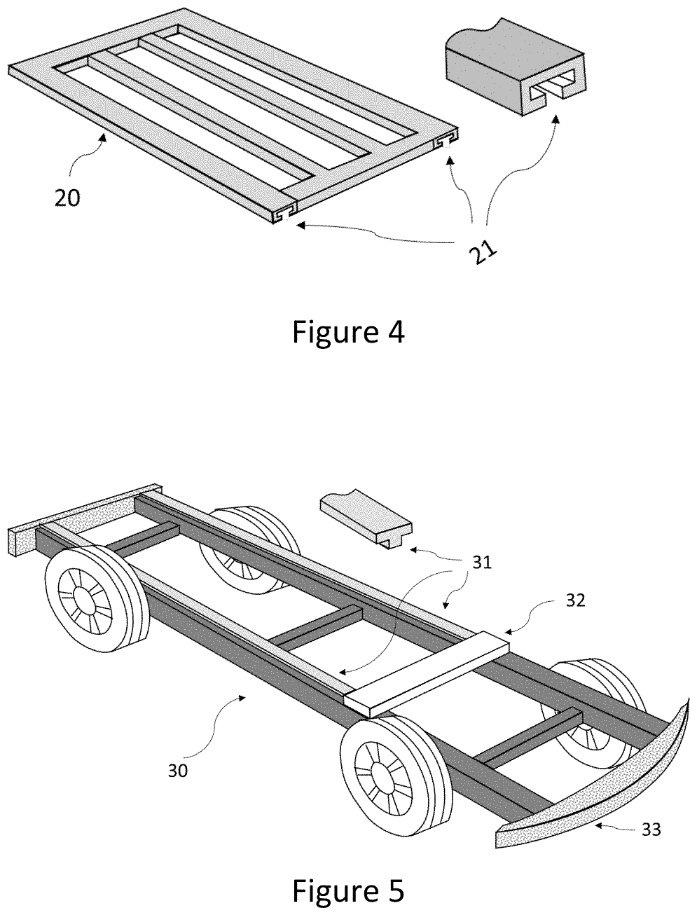

FIG. 4 shows the structures of the seat rack 20. In the said seat rack 20, there is a T-slot 21 on each side, the said T-slots 21 will be mounted into the T-bars 31 which are located on the top of the chassis frame 30 shown in FIG. 5.

FIG. 5 shows the structure of the chassis frame 30, the said slide T bars 31 and the seat-retreat activation unit 32 are on the top of the said chassis frame, and a frontal bumper 33 is located at the frontal end of the said chassis frame 30.

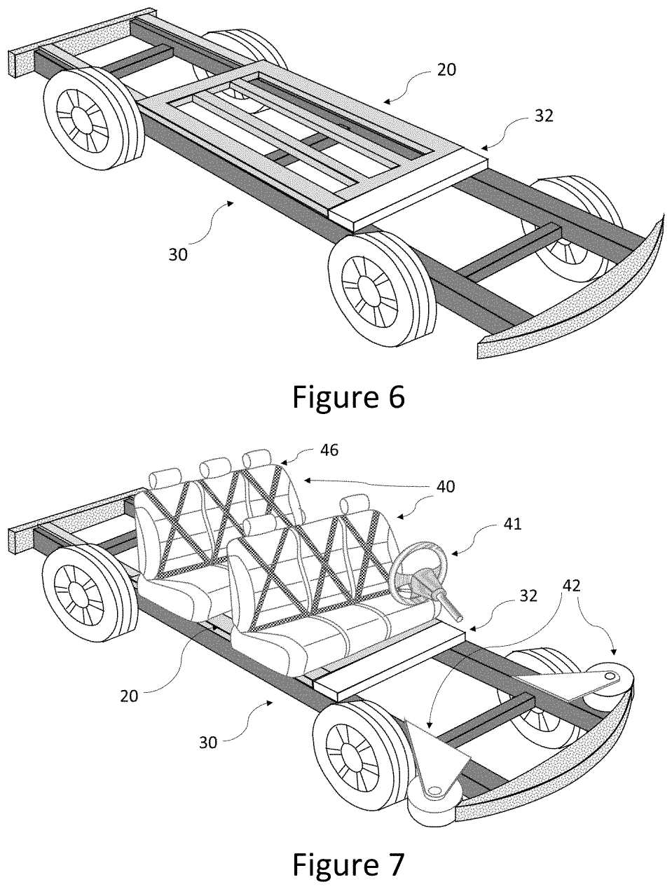

FIG. 6 shows the installation of the said seat rack 20 on the chassis frame 30. The T-slots 21 of the said seat rack 20 smoothly fit to the said slide T bars 31 of the said chassis frame 30 and the said seat rack 20 can slide smoothly on the said chassis frame 30.

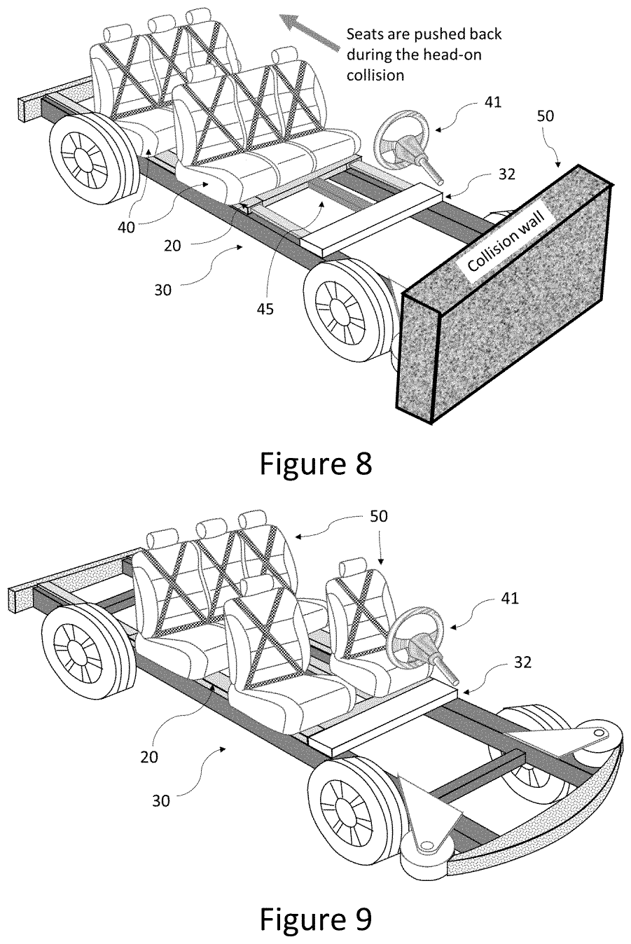

FIG. 7 shows the vehicle seats 40 are installed on the said seat rack 20 and the collision safer devices 42 are installed at the frontal corners of the said chassis frame 30. The seatbelts 46 are installed on the seats 40. When head-on collision happens shown in FIG. 8, the whole structure of FIG. 7 collides perpendicularly into the hard wall 50, if the collision is hard enough, the collision sensor (not shown) will activate the airbags, the said seat rack activation unit 32 and the rear door unlock unit (not shown), the airbags will be deployed, the said seat-retreat activation unit 32 will push the said seat rack 20 backward by the push bar 45 shown in FIG. 8 to create significant open space between the frontal occupants (driver and other passenger if available) and the steering wheel as well as the dashboard, such additional open space as collision cushion will significantly reduce the severity of the collision for the frontal occupants, save lives. The rear door is unlocked by the collision sensor signal, so the trapped or injured occupants can escape from the damaged vehicles if side doors are damaged and cannot be opened, other people at outside can enter the damaged vehicle to rescue or to give the support to the trapped occupants without special tools to cut the vehicles and without waiting for the professional rescue staffs coming, because, at such scenario, time is life.

FIG. 9 shows that two seats are installed at the frontal row for the vehicles without the application of the said steering wheel 11 with dual positions

The invention of the steering wheel with dual positions can be applied to all type of common vehicles, but the invention of the collision-retreat seats requires a chassis frame in which the seats can slide smoothly during the serious front-end collision, the family vans or SUV may be suitable for the application of the such collision-retreat seats. The invention of collision safe devices can be applied to all common vehicles. It is for sure that the vehicles with all those three inventions applied will be much more collision safer in the future, the severity of the injuries, fatal casualties and property damages will be substantially reduced in the collisions. The inventions disclosed here may require completely new design of interior and re-arrangement of parts for the vehicles

Whereas the present invention has been described in particular relation to the drawings attached hereto, it should be understood that other and further modifications based on the actual application, apart from those shown or suggested herein, may be made within the spirit and scope of this invention.

### REFERENCES

[1] Pan, H. (2019) A Possible Collision Safer Device for Automobile Vehicles. Adv Automob Eng 8 (1): 190. doi: 10.4172/2167-7670.1000190
[2] Insurance Institute for Highway Safety Highway Loss Data Institute, IIHS News, Jan. 19, 2011 Collision safer vehicles having a steering wheel with dual positions and collision-retreat seats

What is claimed is:

1. The vehicle is equipped with the steering wheel which can be located and operated either at the side location or at the central location, when the steering wheel is located at the central location, additional collision cushion space is created to substantially reduce the injuries and fatal causalities caused by side collisions.

2. The vehicle is equipped with collision-retreat seats which can be pushed backward through proper mechanism during the front-end collisions, additional collision cushion space is created between the front seats and the steering wheel as well as other frontal elements, the severity of the injuries and fatal casualties can be substantially reduced during the front-end collisions.
